(19) United States
(12) Patent Application Publication
(10) Pub. No.: US 2003/0126209 A1
(43) Pub. Date: Jul. 3, 2003

(54) Network customer service and method for the same

(75) Inventors: Sayling Wen, Taipei (TW); Kuang-Shin Lin, Taipei (TW)

Correspondence Address: EDWARDS & ANGELL, L.L.P., 101 Federal Street, Boston, MA, 02110, US

(73) Assignee: Inventec Corporation

(21) Appl. No.: 10/330,390

(22) Filed: Dec. 27, 2002

(30) Foreign Application Priority Data
Dec. 28, 2001 (TW) 90132711

(51) Int. Cl. G06F 15/16; G06F 17/00

(52) U.S. Cl. 709/204; 707/104.1

(57) ABSTRACT

A network client service system and a method for the same are applied to an Internet environment for accomplishing connection between distant-end users according to data of geographic locations corresponding to TCP/IP addresses of servers and the distant-end users. In particular, users located in particular geographic regions are served by servers specifically designated to provide services at these geographic regions. The servers corresponding to geographic regions where users are located can provide forms of homepages to the users for facilitating collection of user data, and connection between different distant-end users served by a single server or different serves can be accomplished over a network, so as to allow the distant-end users to perform data transfer and electronic commerce services with each other through the use of the network client service system and method.

### FIELD OF THE INVENTION

The present invention relates to network client service systems and methods, and more particularly, to a network client service system and method containing data of geographic locations corresponding to TCP/IP addresses of servers and distant-end users, so as to allow the distant-end users to perform data transfer and electronic commerce services with each other through the use of the network client service system and method.

### BACKGROUND OF THE INVENTION

In respect of data communication and network electronic commerce, a network client service system may often encounter problems associated with client number, client sources, and provision of client services.

For a conventional network client service system, regarding “client number”; it is usually hard to precisely estimate the number of clients from the population in accordance with the requirements and events; in regard to “client sources”, it may not be easy to determine sources of clients and to discover potential clients from the population; and as for providing services to clients, how to divide a client market into different service providing regions is a thorny problem.

Generally, when the conventional network client service system operates a domain name service (DNS) system to provide services, it searches for a TCP/IP address of a network server according to a domain name of the network server inputted by a user and connects the user to the network server. The network server may use small programs such as cookies to obtain a TCP/IP address of the user who browses web pages. However, either the network server or distant-end user fails to know an exact geographic location for the distant-end user or network server, making the network client service system unable to accurately estimate the number of clients, to effectively discover sources of clients and to provide better client services according to regional distribution of the client market.

Therefore, it is greatly desired to provide a network client service system and method to solve the above problems rendered from the conventional network client service system.

### SUMMARY OF THE INVENTION

A primary objective of the present invention is to provide a network client service system and method applied to an Internet environment, whereby distant-end users are allowed to perform data transfer and electronic commerce services with each other according to geographic locations corresponding to TCP/IP addresses of servers and the distant-end users.

Another objective of the invention is to provide a network client service system and method applied to an Internet environment, whereby according to geographic locations corresponding to TCP/IP addresses of servers and the distant-end users, users located in particular geographic regions (corresponding to certain TCP/IP regions) are served by servers specifically designated to provide services at these geographic regions.

A further objective of the present invention is to provide a network client service system and method applied to an Internet environment, whereby servers corresponding to geographic regions where users are located can provide forms of homepages to the users for facilitating collection of user data, and connection between different distant-end users served by a single server or different serves can be accomplished over a network to perform data transfer and electronic commerce.

In accordance with the foregoing and other objectives, the present invention proposes a network client service system and method applied to an Internet environment for accomplishing connection between distant-end users according to data of geographic locations corresponding to TCP/IP addresses of servers and the distant-end users. The network client service system comprises: a plurality of servers linked to each other via a network, each of the servers comprising: a geographic database for storing TCP/IP addresses of the servers and users, and data of geographic locations corresponding to the TCP/IP addresses of the servers and users; a client service module operating in association with the geographic database for designating the servers to provide services for users located at different geographic regions according to geographic locations corresponding to the TCP/IP addresses of the servers and users, and for interconnecting different users compliant with predetermined parameter settings via a network according to conditions of parameter settings for service performance, so as to allow the distant-end users to perform data transfer and electronic commerce with each other; and a client database for storing data of the users, which data are capable of being obtained through the use of the client service module; whereby a form of homepage of the client service module is provided for the users from the server designated to serve at the geographic region where the users are located, allowing data of the users to be collected by means of the form of homepage and stored in the client database by the client service module.

The network client service method according to the invention comprises the steps of: (a) establishing a geographic database via the network client service system in each of the servers linked to each other, the geographic database containing TCP/IP addresses of the servers and users and data of geographic locations corresponding to the TCP/IP addresses of the servers and users; (b) designating the servers to provide services for users located at different geographic regions via the network client service system operating in association with the geographic databases according to geographic locations corresponding to the TCP/IP addresses of the servers and users; (c) providing a form of homepage via a client service modules of the server for users located at a particular geographic region served by the server, and allowing data of users to be collected by means of the form of homepage and stored in a client database of the server, whereby the servers storing data of users in different geographic regions may exchange data of the users to each other via the client service modules thereof and simultaneously update the stored data in the client databases thereof; and (d) according to conditions of parameter settings for service performance, interconnecting via the client service modules of the servers different users that are compliant with the parameter settings and served by a single server or different servers through a network, so as to allow the distant-end users to perform data transfer and electronic commerce with each other.

The above network client service system and method provide significant benefits. According to data of geographic locations corresponding to TCP/IP addresses of servers and distant-end users stored in the network client service system, users located in particular geographic regions (corresponding to certain TCP/IP regions) are served by servers specifically designated to provide services at these geographic regions. The servers corresponding to geographic regions where users are located can provide forms of homepages to the users for facilitating collection of user data, and connection between different distant-end users served by a single server or different serves can be accomplished over a network, so as to allow the distant-end users to perform data transfer and electronic commerce services with each other through the use of the network client service system and method.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram illustrating a basic systematic structure of a network client service system according to the invention;

FIG. 2 is a flowchart illustrating procedural steps of a network client service method through the use of the network client service system according to the invention;

FIG. 3 is a block diagram illustrating a basic systematic structure of the network client service system according to a preferred embodiment of the invention;

FIG. 4 is a flowchart illustrating procedural steps of a network client service method through the use of the network client service system shown in FIG. 3;

FIG. 5 is a table showing a form of a homepage for a client service module in a server of the network client service system shown in FIG. 3; and

FIG. 6 is a table showing a form of the homepage for a client service module in another server of the network client service system shown in FIG. 3.

### DETAILED DESCRIPTION OF THE PREFERRED EMBODIMENTS

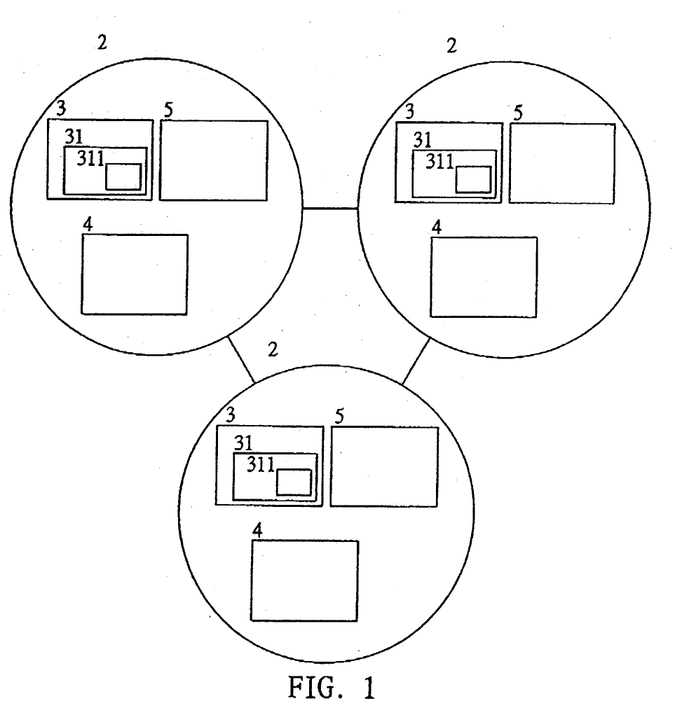

FIG. 1 illustrates a basic systematic structure of a network client service system according to the present invention. As shown in the drawing, the network client service system 1 comprises one or more servers 2 linked to each other via a network, each server 2 including a client service module 3, a client database 4 and a geographic database 5.

The geographic database 5 stores TCP/IP addresses of the servers 2 and users and data of geographic locations (longitude and latitude) corresponding to the TCP/IP addresses of the servers 2 and users.

The client service module 3 may operate in association with the geographic database 5. Depending on the requirements and events, according to geographic locations corresponding to TCP/IP addresses of the servers 2 and distant-end users, the servers 2 are designated to serve users located at different geographic regions corresponding to different TCP/IP regions. Moreover, the client service module 3 may also operate in coordination with the client database 4; according to different conditions of parameter settings that may involve parameters related to geographic locations of the servers 2 and distant-end users, the client service module 3 can connect different distant-end users served by a single server 2 or different servers 2 together via a network for allowing the distant-end users to perform data transfer and electronic commerce.

The client database 4 stores data of distant-end users that can be obtained through a homepage 31 of the client service module 3. In particular, the client service module 3 of a server 2 serving at a particular geographic region corresponding to a TCP/IP region of users can provide the users with a form 311 of homepage 31 used to collect user data that are to be stored in the client database 4 by the client service module 3.

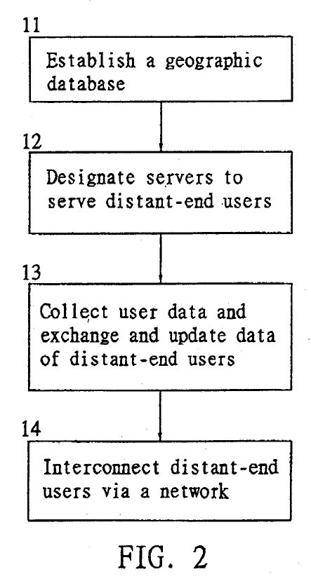

FIG. 2 illustrates procedural steps of a network client service method through the use of the network client service system according to the invention. As shown in the drawing, first in step 11, the network client service system 1 establishes a geographic database 5 in each of the servers 2 linked to each other via a network. The geographic database 5 contains TCP/IP addresses of the servers 2 and users and data of geographic locations corresponding to the TCP/IP addresses of the servers 2 and users. Then, step 12 is performed.

In step 12, after the geographic databases 5 are established, the client service module 3 of the servers 2 in the network client service system 1 can operate in association with the geographic databases 5. Depending on the requirements and events, users located at particular geographic regions (corresponding to certain TCP/IP regions) are adapted to be served by one or more servers 2 specifically designated to provide services at these geographic regions according to geographic locations corresponding to TCP/IP addresses of the server 2 and distant-end users. That is, the servers 2 are assigned for serving corresponding distant-end users. Then, step 13 is performed.

In step 13, the client service module 3 of the server 2 serving at a particular geographic region corresponding to a TCP/IP region of users provides a form 311 of homepage 31 of the client service module 3 used to collect user data that are to be stored in the client database 4 by the client service module 3. In the case of a plurality of servers 2 being provided, the servers 2 may exchange data of distant-end users stored in the client databases 4 via the client service modules 3 thereof so as to simultaneously update user data in the client databases 4. Then, step 14 is performed.

In step 14, the client service module 3 operates in coordination with the corresponding client database 4 and geographic database 5 according to different conditions of parameter settings in a manner that, different distant-end users that match the parameter settings and are served by the same server 2 or different servers 2, are linked to each other via a network through the use of the network client service system 1 for performing data transfer and electronic commerce.

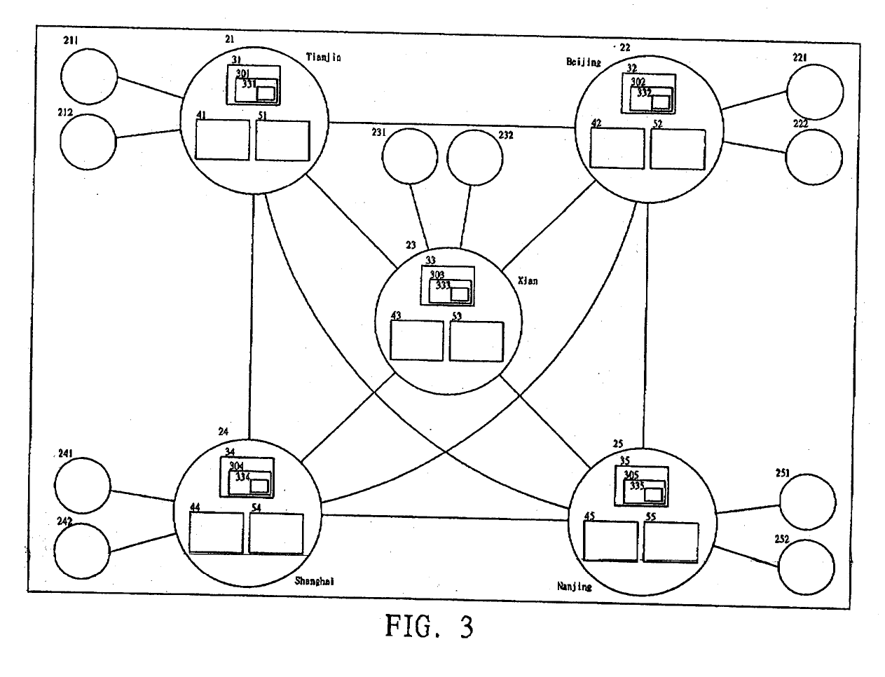

FIG. 3 illustrates a basic systematic structure of the network client service system according to a preferred embodiment of the invention. As shown in the drawing, the network client service system 1 includes five servers 21, 22, 23, 24, 25 linked to each other via a network, wherein the servers 21, 22, 23, 24, 25 have client service modules 31, 32, 33, 34, 35, client databases 41, 42, 43, 44, 45, and geographic databases 51, 52, 53, 54, 55, respectively. Distant-end users 211, 212 are connected to the server 21; distant-end users 221, 222 are connected to the server 22; distant-end users 231, 232 are connected to the server 23; distant-end users 241, 242 are connected to the server 24; distant-end users 251, 252 are connected to the server 25.

Each of the servers 21, 22, 23, 24, 25 is provided with a unique TCP/IP address and geographic location that are stored in the corresponding geographic database 51, 52, 53, 54, 55. For example of the network client service system 1 being constructed in China, the server 21 may be located at Tientsin City, the server 22 may be located at Beijing City, the server 23 may be located at Sian City, the server 24 may be located at Shanghai City, and the server 25 may be located at Nanking City. The geographic databases 51, 52, 53, 54, 55 further contain TCP/IP addresses of the distant-end users 211, 212, 221, 222, 231, 232, 241, 242, 251, 252 and their corresponding data of geographic locations.

The client service modules 31, 32, 33, 34, 35 may operate in association with the geographic databases 51, 52, 53, 54, 55. Depending on the requirements and events, according to geographic locations corresponding to TCP/IP addresses of the servers 21, 22, 23, 24, 25 and distant-end users 211, 212, 221, 222, 231, 232, 241, 242, 251, 252, users located at particular geographic regions (corresponding to certain TCP/IP regions) are served by serves designated to provide service at these geographic regions such as Tientsin City, Beijing City, Sian City, Shanghai City, and Nanking City. The client service modules 31, 32, 33, 34, 35 also operates in coordination with the client databases 41, 42, 43, 44, 45, according to different conditions of parameter settings, different distant-end users that match the parameter settings and are served by the servers 21, 22, 23, 24, 25, can be connected to each other; for example, the distant-end users 211, 241 are allowed to be linked together via a network through the use of the network client service system 1 for performing data transfer and electronic commerce.

The client databases 41, 42, 43, 44, 45 contain data of distant-end users that can be obtained through homepages 301, 302, 303, 304, 305 of the client service modules 31, 32, 33, 34, 35. In particular, the client service modules 31, 32, 33, 34, 35 of the servers 21, 22, 23, 24, 25 serving at geographic regions corresponding to TCP/IP regions of users provide forms 331, 332, 333, 334, 335 of the homepages 301, 302, 303, 304, 305 that are used to collect data of the distant-end users 211, 212, 221, 222, 231, 232, 241, 242, 251, 252, and the collected user data are stored in the corresponding client databases 41, 42, 43, 44, 45 by the client service modules 31, 32, 33, 34, 35.

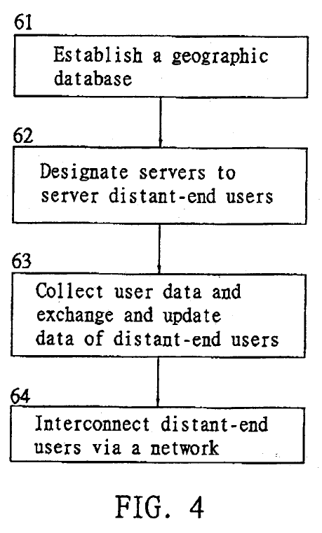

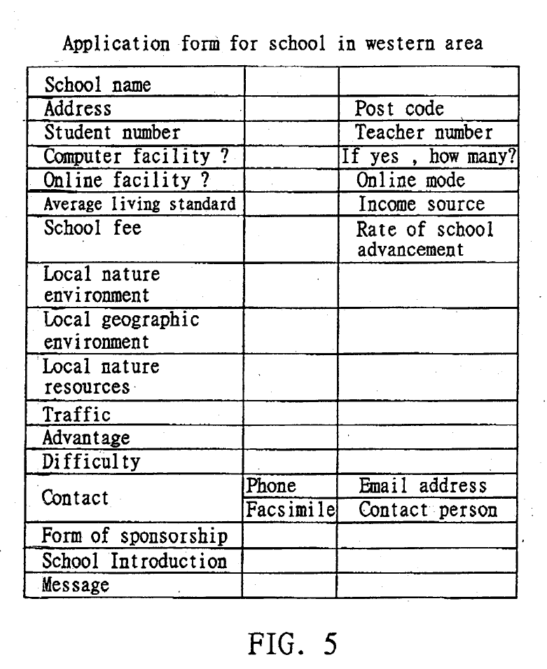

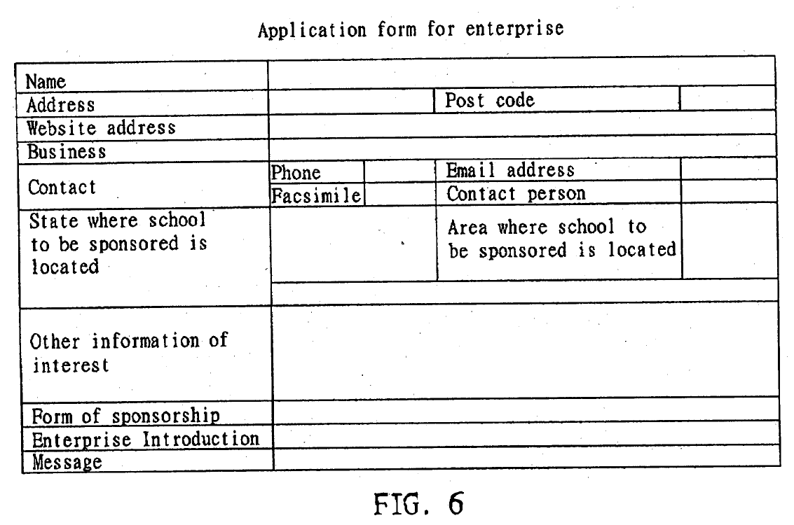

FIG. 4 illustrates procedural steps of a network client service method through the use of the network client service system shown in FIG. 3. In this embodiment, the distant-end user 211 is connected to the distant-end user 241 through the use of the network client service system 1 for the following interpretation. The server 21 located in Tientsin City is linked with the distant-end user 211 and provides the distant-end user 211 with the form 331 of homepage 301 from the client service module 31, as shown in FIG. 5, so as to obtain user data of the distant-end user 211, which is a school for example. The server 24 located in Shanghai City is linked with the distant-end user 241 and provides the distant-end user 241 with the form 334 of homepage 304 from the client service module 34, as shown in FIG. 6, so as to obtain user data of the distant-end user 241, which is an enterprise in this case.

As shown in FIG. 4, first in step 61, the network client service system 1 establishes geographic databases 51, 52, 53, 54, 55 respectively in the servers 21, 22, 23, 24, 25. The geographic databases 51, 52, 53, 54, 55 contain TCP/IP addresses of the server 21, 22, 23, 24, 25 and distant-end users 211, 212, 221, 222, 231, 232, 241, 242, 251, 252, as well as data of geographic locations corresponding to the TCP/IP addresses of the server 21, 22, 23, 24, 25 and distant-end users 211, 212, 221, 222, 231, 232, 241, 242, 251, 252. Then, step 62 is performed.

In step 62, after the geographic databases 51, 52, 53, 54, 55 are established, the client service modules 31, 32, 33, 34, 35 of the servers 21, 22, 23, 24, 25 can operate respectively in association with the geographic databases 51, 52, 53, 54, 55. Depending on the requirements and events, according to geographic locations corresponding to TCP/IP addresses of the servers 21, 22, 23, 24, 25 and distant-end users 211, 212, 221, 222, 231, 232, 241, 242, 251, 252, users located at particular geographic regions (corresponding to certain TCP/IP regions) are served by serves designated to provide service at these geographic regions such as Tientsin City, Beijing City, Sian City, Shanghai City, and Nanking City. For example, the server 21 located in Tientsin City provides serves for the distant-end user 211, and the server 24 located in Shanghai City serves the distant-end user 241. Then, step 63 is performed.

In step 63, the server 21 located in Tientsin City is linked to the distant-end user 211 and provides the distant-end user 211 with the form 331 of homepage 301 from the client service module 31 to thereby obtain user data of the distant-end user 211, as shown in FIG. 5 illustrating the form 331 in which the distant-end user 211 is a school. The server 24 located in Shanghai City is linked to the distant-end user 241 and provides the distant-end user 241 with the form 334 of homepage 304 from the client service module 34, so as to obtain user data of the distant-end user 241, as shown in FIG. 6 illustrating the form 334 in which the distant-end user 241 is an enterprise. These forms 331, 334 of homepages 301, 304 are used to collect data of the distant-end users 211, 241, and the collected user data are stored in the client databases 41, 44 by the client service modules 31, 34. With a plurality of server 21, 22, 23, 24, 25 being provided, the servers 21, 22, 23, 24, 25 can exchange data of the distant-end users 211, 241 in the client databases 41, 42,, 43, 44, 45 through the client service modules 31, 32, 33, 34, 35 so as to simultaneously update data of the distant-end users 211, 241 in the client databases 41, 42, 43, 44, 45. Then, step 64 is performed.

In step 64, according to a condition of parameter settings in which an enterprise “adopts” a school, the servers 21, 24 in the network client service system 1 operates the client service modules 31, 34 and the client databases 41, 44 in coordination with the geographic databases 51, 54, so as to search for data of the distant-end users 211, 241 from the client databases 41, 44, and to connect the distant-end user 211 to the distant-end user 241 in a manner that that the distant-end user 211 (school) is adopted by the distant-end user 241 (enterprise). For example, the distant-end user 211 (school) that may be located at a remote area or not have sufficient or advanced advertisement facilities, can be promoted through the distant-end user 241 (enterprise) to increase the number of students attending the school; on the other hand, the enterprise may gain benefits for performing advertisement or promotion for the school.

Therefore, the network client service system and method according to the invention provide significant benefits. According to data of geographic locations corresponding to TCP/IP addresses of servers and distant-end users stored in the network client service system, users located in particular geographic regions (corresponding to certain TCP/IP regions) are served by servers specifically designated to provide services at these geographic regions. The servers corresponding to geographic regions where users are located can provide forms of homepages to the users for facilitating collection of user data, and connection between different distant-end users served by a single server or different serves can be accomplished over a network, so as to allow the distant-end users to perform data transfer and electronic commerce services with each other through the use of the network client service system and method.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A network client service method applied to an Internet environment and utilizing a network client service system for accomplishing connection between distant-end users according to data of geographic locations corresponding to TCP/IP addresses of servers and the distant-end users, the network client service method comprising the steps of:
(a) establishing a geographic database via the network client service system in each of the servers linked to each other, the geographic database containing TCP/IP addresses of the servers and users and data of geographic locations corresponding to the TCP/IP addresses of the servers and users;
(b) designating the servers to provide services for users located at different geographic regions via the network client service system operating in association with the geographic databases according to geographic locations corresponding to the TCP/IP addresses of the servers and users;
(c) providing a form of homepage via a client service modules of the server for users located at a particular geographic region served by the server, and allowing data of users to be collected by means of the form of homepage and stored in a client database of the server, whereby the servers storing data of users in different geographic regions may exchange data of the users to each other via the client service modules thereof and simultaneously update the stored data in the client databases thereof; and
(d) according to conditions of parameter settings for service performance, interconnecting via the client service modules of the servers different users that are compliant with the parameter settings and served by a single server or different servers through a network, so as to allow the distant-end users to perform data transfer and electronic commerce with each other.

2. The network client service method of claim 1, wherein the parameter settings involve parameters related to geographic locations of the servers and users.

3. The network client service method of claim 2, wherein the geographic location includes longitude and latitude.

4. A network client service system applied to an Internet environment, for accomplishing connection between distant-end users according to data of geographic locations corresponding to TCP/IP addresses of servers and the distant-end users, the network client service system comprising:
a plurality of servers linked to each other via a network, each of the servers comprising:
a geographic database for storing TCP/IP addresses of the servers and users, and data of geographic locations corresponding to the TCP/IP addresses of the servers and users;
a client service module operating in association with the geographic database for designating the servers to provide services for users located at different geographic regions according to geographic locations corresponding to the TCP/IP addresses of the servers and users, and for interconnecting different users compliant with predetermined parameter settings via a network according to conditions of parameter settings for service performance, so as to allow the distant-end users to perform data transfer and electronic commerce with each other; and
a client database for storing data of the users, which data are capable of being obtained through the use of the client service module;
whereby a form of homepage of the client service module is provided for the users from the server designated to serve at the geographic region where the users are located, allowing data of the users to be collected by means of the form of homepage and stored in the client database by the client service module.

5. The network client service system of claim 4, wherein the parameter settings involve parameters related to geographic locations of the servers and users.

6. The network client service system of claim 5, wherein the geographic location includes longitude and latitude.
